(19) United States
(12) Patent Application Publication
(10) Pub. No.: US 2013/0209063 A1
(43) Pub. Date: Aug. 15, 2013

(54) DIGITAL RECEIVER AND CONTENT PROCESSING METHOD IN DIGITAL RECEIVER

(71) Applicants: Jongyeul Suh, Seoul (KR); Jeehyun Choe, Seoul (KR); Joonhui Lee, Seoul (KR)

(72) Inventors: Jongyeul Suh, Seoul (KR); Jeehyun Choe, Seoul (KR); Joonhui Lee, Seoul (KR)

(73) Assignee: LG Electronics Inc., Seoul (KR)

(21) Appl. No.: 13/817,369

(22) PCT Filed: Aug. 17, 2011
(86) PCT No.: PCT/KR11/06018

§ 371 Date: Apr. 8, 2013

Related U.S. Application Data
(60) Provisional application No. 61/374,278, filed on Aug. 17, 2010.

(51) Int. Cl. H04N 13/00

(52) U.S. Cl. CPC H04N 13/0055
USPC 386/241

(57) ABSTRACT

The present invention relates to a digital receiver and a content processing method in a digital receiver. One embodiment of a digital receiver for 3D service according to the present invention comprises: a download module which performs a control such that a time-stamp is added to an input 3D-video elementary stream, and the input 3D-video elementary stream is stored; a PVR module including an upload module, which extracts the stored 3D-video elementary stream and uploads a system clock on the basis of a time-stamp value of the extracted 3D-video elementary stream; a decoder which decodes the uploaded 3D-video elementary stream; a formatter which formats decoded 3D video data based on an output format; and an output unit which outputs the formatted 3D video data.

### TECHNICAL FIELD

The present invention relates to a digital receiver, and more particularly, to a digital receiver capable of storing and playing back 3-dimensional (3D) content through a Personal Video Recorder (PVR) which can receive and store 3D signals and a method for processing content in the digital receiver.

### BACKGROUND ART

While analog broadcasting and digital broadcasting have been simultaneously used, analog broadcasting has recently been ended all around the world and transition to digital broadcasting has been completed.

As digital broadcasting rapidly spreads, various types of content have been developed in comparison with analog broadcasting and various digital broadcasting technologies for user convenience, capable of using content more easily and conveniently, have been developed.

For example, while most conventional content is 2D content, interest in realistic and stereoscopic 3D content has increased as digital broadcasting becomes widespread and 3D content has been developed. In addition, even in a digital receiver, various research into storage and playback of 3D content has been conducted.

Meanwhile, although a broadcast environment has transitioned to digital broadcasting from analog broadcasting, there is a high probability of a mixture of 2D content and 3D content even in a digital broadcasting environment. Accordingly, a digital receiver should be able to appropriately process both 2D and 3D content. In spite of interest of users in 3D content, processing of 3D content in the digital receiver is problematic and conversion of 2D/3D content does not provide suitable user satisfaction.

### DETAILED DESCRIPTION OF THE INVENTION

### Technical Problems

An object of the present invention devised to solve the above problem lies in providing a digital receiver for storing and playing back 3D content through a PVR which can receive and store 3D signals and supporting functions such as 2D/3D conversion and view switching during the storage and playback of the 3D content and a method for processing content in the digital receiver.

It is another object of the present invention to provide a digital receiver for supporting effective PVR functions with respect to a 3D stream for full-resolution-per-eye implementation rather than frame compatible implementation and a method for processing content in the digital receiver.

### Technical Solutions

To achieve the above technical object, this specification proposes the following technical solutions.

In accordance with the present invention, a method for processing a digital broadcast signal for a 3-dimensional (3D) service includes adding a time-stamp to an input 3D video elementary stream and storing the time-stamped 3D video elementary stream; extracting the stored 3D video elementary stream and uploading the extracted 3D video elementary stream according to a system clock based on a time-stamp value of the extracted 3D video elementary stream; decoding the uploaded 3D video elementary stream; and formatting decoded 3D video data to suit an output format and outputting the formatted 3D video data.

The method may further include analyzing the input 3D video elementary stream, and generating index data for trick play according to the analyzed result and storing the index data.

The 3D video elementary stream is a dual video stream composed of a base layer video stream and an enhancement layer video stream.

The time-stamp may be added to a transport packet of a prescribed unit among transport packets for the input 3D video elementary stream.

The time-stamp may be added to a first transport packet received after a discontinuity interval generated during a packet identifier (PID) filtering process, among transport packets for the input 3D video elementary stream.

In accordance with the present invention, a digital receiver for a 3-dimensional (3D) service includes a Personal Video Recorder (PVR) module including a download module for adding a time-stamp to an input 3D video elementary stream and storing the time-stamped 3D video elementary stream and an upload module for extracting the stored 3D video elementary stream and uploading the extracted 3D video elementary stream according to a system clock based on a time-stamp value of the extracted 3D video elementary stream; a decoder for decoding the uploaded 3D video elementary stream; a formatter for formatting decoded 3D video data to suit an output format; and an output part for outputting the formatted 3D video data.

The download module may analyze the input 3D video elementary stream, and generate and store index data for trick play according to the analyzed result.

The 3D video elementary stream may be a dual video stream composed of a base layer video stream and an enhancement layer video stream.

The download module may add the time-stamp to a transport packet of a prescribed unit among transport packets for the input 3D video elementary stream.

The download modules may add the time-stamp to a first transport packet received after a discontinuity interval generated during a packet identifier (PID) filtering process, among transport packets for the input 3D video elementary stream.

### ADVANTAGEOUS EFFECTS

According to the present invention,

First, the digital receive can provide various PVR functions for 3D content.

Second, the digital receiver can support effective PVR functions even for a 3D stream for carrying out full-resolution-per-eye.

Third, the digital receiver can smoothly perform trick play and 2D/3D conversion functions even for 3D content using a PVR.

### BRIEF DESCRIPTION OF THE DRAWINGS

FIG. 1 is a block diagram illustrating an exemplary configuration of a digital receiver including a 3D PVR module according to the present invention;

FIG. 2 is a block diagram illustrating an exemplary configuration of a 3D PVR module in FIG. 1;

FIG. 3 is a block diagram illustrating an exemplary configuration of a download module included in the 3D PVR module of FIG. 2;

FIG. 4 to FIG. 6 are diagrams illustrating exemplary implementation of time-stamp insertion in a download module according to the present invention;

FIG. 7 is a diagram illustrating a data structure of a time-stamp index during use of a time-stamp according to the present invention;

FIG. 8 is a diagram illustrating an exemplary index configuration in a download module according to the present invention

FIG. 9 is a block diagram illustrating an exemplary configuration of an upload module included in the 3D PVR module of FIG. 2

FIG. 10 is a flowchart illustrating an exemplary operation of the receiver during 2D/3D recording according to the present invention;

FIG. 11 is a flowchart illustrating an exemplary operation of the receiver during 2D mode playback according to the present invention;

FIG. 11 is a flowchart illustrating an exemplary operation of the receiver during 3D mode playback according to the present invention; and

FIG. 13 is flowchart illustrating an exemplary operation of the digital receiver during a view switching request according to the present invention.

### BEST MODE FOR CARRYING OUT THE INVENTION

The present invention will be described in more detail with reference to the attached drawings.

The suffixes “module” and “part” of constituent elements used in the following description are given only for the purpose of ease of description of the present specification and “module” and “part” are used interchangeably.

While the embodiments of the present invention will be described below with reference to the accompanying drawings and the contents disclosed in the accompanying drawings, the present invention is not limited to such embodiments.

Terms disclosed in the present invention are defined in consideration of functions of the present invention and correspond to general terms well known in the art and may vary according to intention of those skilled in the art, usual practices, or introduction of new technologies. Some of the terms mentioned in the description of the present invention may have been selected by the applicant at his or her discretion, and in such cases the detailed meanings thereof will be described in relevant parts of the description herein. Thus, the terms used in this specification should be interpreted based on the substantial meanings of the terms and the whole content of this specification rather than their simple names or meanings.

The present invention relates to a digital receiver, and more particularly, to a digital receiver capable of storing and reproducing or playing back 3D content through a PVR which can receive and store 3D signals and a method for processing content in the digital receiver.

Especially, this specification describes a digital receiver for storing and playing back 3D content through a PVR and supporting various PVR functions such as 2D/3D conversion and view switching during the storing and playing processes and a method for processing content in the digital receiver according to the present invention.

Of a frame compatible system and a full-resolution-per-eye system for 3D implementation in a digital receiver, the full-resolution-per-eye system will be described hereinbelow for understanding of the present invention and convenience of description. Nonetheless, the present invention is not limited to the full-resolution-per-eye system and other systems related to the present invention may be applied to the present invention according to the same or similar principle.

The frame compatible system refers to a system reusing a conventional structure when a digital receiver records 3D content through a PVR. In contrast, the full-resolution-per-eye system such as a Multiview Video Coding (MVC), Scalable Video Coding (SVC), or dual codec system needs a more efficient method to support 2D/3D conversion, trick play including skip, and view switching. To this end, this specification defines and describes a time-stamp, PVR indexing, thumbnail extraction, etc. to provide a 3D service according to the present invention.

In relation to the present invention, when a digital receiver desires to perform functions such as 3D content storage, 3D content playback, time shift, etc. using a PVR, especially, in case of a dual video stream other than a single video stream, a processing method which is different from that in the single video stream or an efficient method is needed. For example, if a user requests trick play among PVR functions, the digital receiver requires selective processing of streams necessary for performing the trick play function. However, in case of the dual video stream, identification and processing of each Elementary Stream (ES) should be performed during a download or storage process. Otherwise, trick play according to a user request cannot be smoothly processed. This is identically applied even when trick play is requested by a user in a 2D/3D mode through PVR functions.

Hereinafter, this specification describes a digital receiver capable of processing various functions such as recording, storing, and playback including trick play of 3D content with respect to a dual video stream used in the full-resolution-per-eye system according to the present invention, and a method for processing content in the digital receiver.

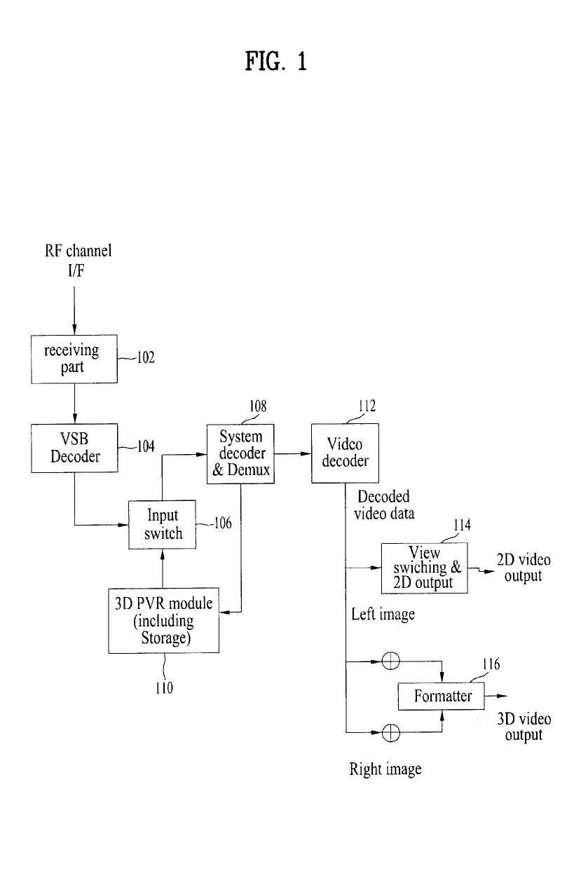

FIG. 1 is a block diagram illustrating an exemplary configuration of a digital receiver including a 3D PVR module according to the present invention.

Referring to FIG. 1, the digital receiver according to the present invention includes a receiving part 102, a VSB decoder 104, an input switch part 106, a system decoder/demultiplexer (Demux) 108, a 3D PVR module 110, a video decoder 112, a view switching/2D output part 114, and a formatter 116.

Although not shown in FIG. 1, the digital receiver may be one receiver set including a display device or a display part (hereinafter, ‘display device’) or a Set-Top Box (STB) to which a display device is connected through an interface. Especially, in the latter case, the interface may be a High Definition Multimedia Interface (HDMI) for interfacing the STB and the display device and the HDMI (not shown) may be connected to the STB and the display device. To use the HDMI, a 3D signaling method defined in HDMI specification may be applied. Accordingly, even in the latter case, 3D content processed in the STB to perform PVR functions can be output in the display device without any problem.

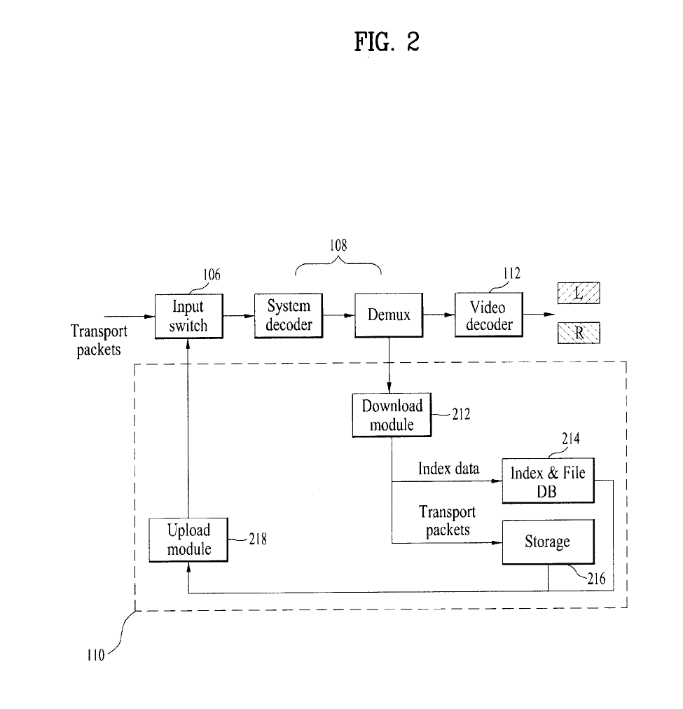

While the digital receiver of FIG. 1 shows only a partial configuration for convenience of description, configurations necessary for performing a specific function may be further included or some configurations may be omitted. In addition, each block shown in FIG. 1 may be added to as a module or may be split into individual configurations. For example, while the system decoder/Demux in FIG. 1 is shown and described as one configuration for convenience, a system decoder and a Demux are distinguished in FIG. 2 for a more clear description.

Each block configuration of the digital receiver of FIG. 1 will be described below in detail.

The receiving part 102, which includes, for example, a tuner and a demodulator, tunes to a Radio Frequency (RF) channel and receives and demodulates a digital signal through the tuned RF channel. Here, the digital signal is a Moving Picture Experts Group-2 (MPEG-2) transmission stream and includes Packetized Elementary Streams (PESs) generated by packetizing Elementary Streams (ESs) including audio, video, and signaling information for processing the audio and/or video.

Specifically, in association with a 3D service according to the present invention, a video stream may be, for example, a single video ES or may be a dual video ES composed of a base layer and an enhancement layer. In case of the former, i.e. if the video stream is a single video ES (e.g. a side-by-side format or a top-and-bottom format), since each of left image data and right image data has half resolution, a configuration such as a scaler (not shown) may be needed. On the other hand, in case of the latter, i.e. if the video stream is a dual video ES, video decoders, which will be described later, for example, one video decoder for decoding a base layer video ES and one video decoder for decoding an enhancement layer video ES are needed. Namely, at least two video decoders are needed. Especially, for the enhancement layer video ES, a plurality of decoders may be required to perform appropriate decoding corresponding to various coding schemes.

In addition, in association with a 3D service according to the present invention, as the signaling information, System Information or Service Information (SI) may be used. The SI may include various information such as Program Specific Information (PSI), Program and System Information Protocol (PSIP), and Digital Video Broadcasting-Service Information (DVB-SI).

In Europe for example, in DVB-SI and MPEG-2, a transmitted transport stream defines signaling information about information identifying a 3D service or 3D content, video format information, codec information, information as to presence/absence of a subtitle, information identifying the subtitle, and 2D/3D linkage information, through table information of a Network Information Table (NIT), a Service Description Table (SDT), an Event Information Table (EIT), a Program Association Table (PAT), a Program Map Table (PMT), etc., descriptors belonging to corresponding tables, a Supplemental Enhancement Information (SEI) message in a video stream, or an additional SEI message. Although not shown in FIG. 1, the digital receiver may further include a system information processor and a database to process 3D signaling. Alternatively, the system decoder 108, which will be described later, may perform a function of the signaling information processor. Further, although not described in detail in this specification, details of definitions and functions of related tables and descriptors may be used in the digital receiver and a content processing procedure of the digital receiver.

The VSB decoder 104 performs VSB decoding with respect to the demodulated digital signal. While a VSB scheme is illustrated for convenience, the present invention is not limited thereto and it is apparent that a Quadrature Amplitude Modulation (QAM) or a Quadrature Phase-Shift Keying (QPSK) scheme may be used.

The input switch part 106 switches transport streams input to the system decoder 108. In a PVR playback mode, the input switch part 106 outputs stored content input from a storage part to the system decoder 108 through an upload module which will be described later and, in a live broadcast view mode, the input switch part 106 outputs transport packets received via RF input, the receiving part 102 and the VSB decoder 104 to the system decoder 108.

The system decoder 108 decodes the input transport streams or decodes the transport packets for stored content, transmitted from the 3D PVR module 112. The system decoder 108 controls the demultiplexer when a PVR mode is requested so that a demultiplexed video ES may be transmitted to the 3D PVR module 110. The system decoder 108 transmits the decoded transport streams or the transport packets for stored content to the video decoder 112. The system decoder 108 decodes information necessary for the digital receiver and may perform a control function for controlling the overall system.

The demultiplexer demultiplexes various ESs including audio, video, and signaling information from the decoded transport streams. If the digital receiver is in a PVR mode, the demultiplexed video ESs are transmitted to the 3D PVR module 110. In a playback mode among PVR functions, video data passing through the system decoder 108 bypasses the demultiplexer and may be transmitted to the video decoder 112.

The 3D PVR module 110 receives transport packets for a video ES input through the system decoder/demultiplexer 108, processes the transport packets for a PVR mode operation, and transmits the processed transport packets to the input switch part 106. The detailed configuration and functions of the 3D PVR module 110 will be described later and omitted herein.

The video decoder 112 decodes video data processed in the system decoder/demultiplexer 108. The video decoder 112 may decode the video data based on the signaling information demultiplexed in the demultiplexer. The video decoder 112 transmits decoded 2D video data to the view switching/2D output part 114 and transmits decoded 3D video data to the formatter 116.

The view switching/2D output part 114 outputs the video data received from the video decoder 112 to a display device so as to generate/play back 2D video. The view switching/2D output part 114 may change from 3D view to 2D view in response to a view switching command according to a user request.

The formatter 116 receives an input left image and an input right image, formats the left and right images to be suitable for an output frequency or an output format, and outputs the formatted images to the display device. If an input video ES is a 2D single video ES, a Frame Rate Control (FRC) block may be located in front of the formatter 116 so that proper processing for a 3D image may be performed.

FIG. 2 is a block diagram illustrating an exemplary configuration of the 3D PVR module in FIG. 1.

In FIG. 2, a detailed block configuration of the above-described 3D PVR module 110 in FIG. 1 is shown.

Referring to FIG. 2, the 3D PVR module 110 according to the present invention includes a download module 212, an index and file database (DB) 214, a storage part 216, and an upload module 218.

Overall operation of the 3D PVR module 110 will now be described with reference to FIG. 1 and FIG. 2.

The transport streams generated from the VSB decoder 104 in FIG. 1 are input to the input switch part 106. Here, the input switch part 106 operates in a first mode. The first mode refers to a procedure for processing the input transport streams. In the first operating mode, if the input switch part 106 transmits the transport streams to the system decoder 108, the system decoder 108 transmits the transport streams to the demultiplexer 108 after basic processing. The demultiplexer 108 demultiplexes the input transport streams to ESs including audio, video, and signaling information.

As described earlier, the demultiplexer 108 transmits the transport packets for the demultiplexed video ESs to the download module 212, in association with the present invention. The download module 212 inserts time-stamps into the input transport packets for the input video ESs and transmits the time-stamped transport packets to the storage part 216 to store the transport packets. The download module 212 generates index data for the stored transport packets and transmits the index data to the index and file DB 214. The upload module 218 extracts the transport packets stored in the storage part 216 upon reception of a PVR playback request. The upload module 218 uploads the transport packets to the input switch part 106. The input switch part 106 outputs the input transport packets to the system decoder 108 according to a PVR playback mode. The system decoder 108 transmits the transport packets input from the input switch part 106 directly to the demultiplexer 108 or to the video decoder 112. The video decoder 112 decodes the input transport packets and generates video data. In this case, the video decoder 112 may appropriately decode the input transport packets based on the signaling information transmitted from the system decoder 108. After decoding the input transport packets, the video decoder 112 generates corresponding data having a related configuration according to whether transport packets correspond to 2D video data or 3D video data.

A user may request the digital receiver to perform a trick mode during a PVR playback process. In this case, the upload module 218 in the 3D PVR module 110 reads the index data, from the index and file DB 214, extracts proper transport packets from the transport packets stored in the storage part 216 based on the read index data, and transmits the extracted transport packets to the input switch part 106. Subsequent processes are the same as the previously described processes.

A brief description of the overall operation has been given above.

Next, operations and functions of each constituent element of the 3D PVR module 110 will be described in more detail.

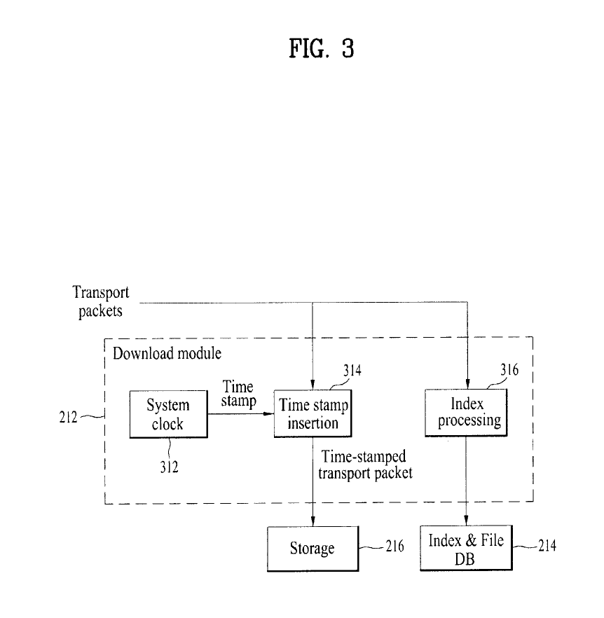

FIG. 3 is a block diagram illustrating an exemplary configuration of the download module 212 included in the 3D PVR module 110 of FIG. 2.

In particular, FIG. 3 illustrates operation and function of the download module 212. The download module 212 receives the transport packets for the video ESs demultiplexed in the demultiplexer 108 and processes time-stamps and/or performs an indexing procedure.

The download module 212 basically performs an operation for storing a Packet Identifier (PID) stream corresponding to a recording program among the transport streams input to the system decoder 108.

Referring to FIG. 3, the download module 212 may include a system clock part 312, a time-stamp insertion part 314, and an index processing part 316. The index processing part 316 performs an indexing procedure for convenience of trick play in a PVR playback mode and may be unnecessary in a basic playback mode. Accordingly, the index processing part 316 may be omitted according to circumstances.

Processing of the time-stamp is to match an input timing of transport packets, which correspond to video ESs recorded and stored through the download module 212 and are to be uploaded through the upload module 218 in a subsequent playback process, to the system decoder 108 with a timing of transport streams input to the system decoder 108 when stored.

A time-stamp processing scheme may basically include three types: a first type of inserting a time-stamp into every transport packet input from the demultiplexer 108, a second type of inserting a time-stamp into every transport packet of a prescribed unit, and a third type of adaptively inserting a time-stamp. A time-stamp processing scheme of aperiodically inserting a time-stamp may be used as opposed to the first type of inserting a time-stamp into every transport packet and the second type of periodically inserting a time-stamp.

According to the first type, a time-stamp (4 bytes) is attached to every transport packet (188 bytes) input to the download module 212 to form a 192-byte time-stamped transport stream.

The second and third types serve to minimize overhead caused by time-stamps and can raise system efficiency by determining whether to insert a time-stamp into an input transport packet to adaptively add the time-stamp.

For example, during time-stamp processing, input data is a transport packet to be stored and a time-stamp corresponding to a PCR value when the corresponding transport packet is input is added to the transport packet. Consequently, a 4-byte time-stamp is inserted to output a 192-byte time-stamped transport stream.

A method for adaptively inserting a time-stamp according to the present invention will be described below in more detail.

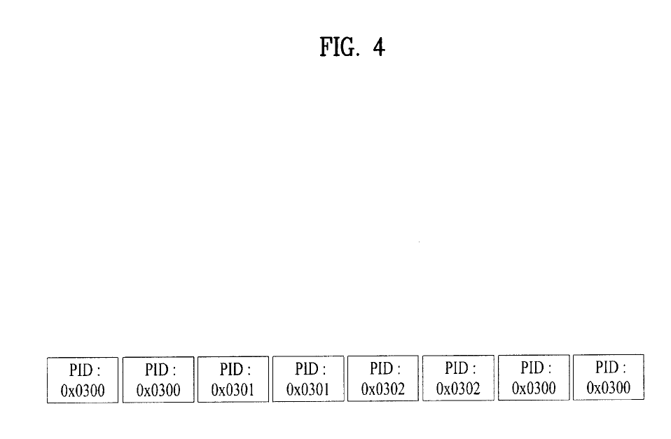

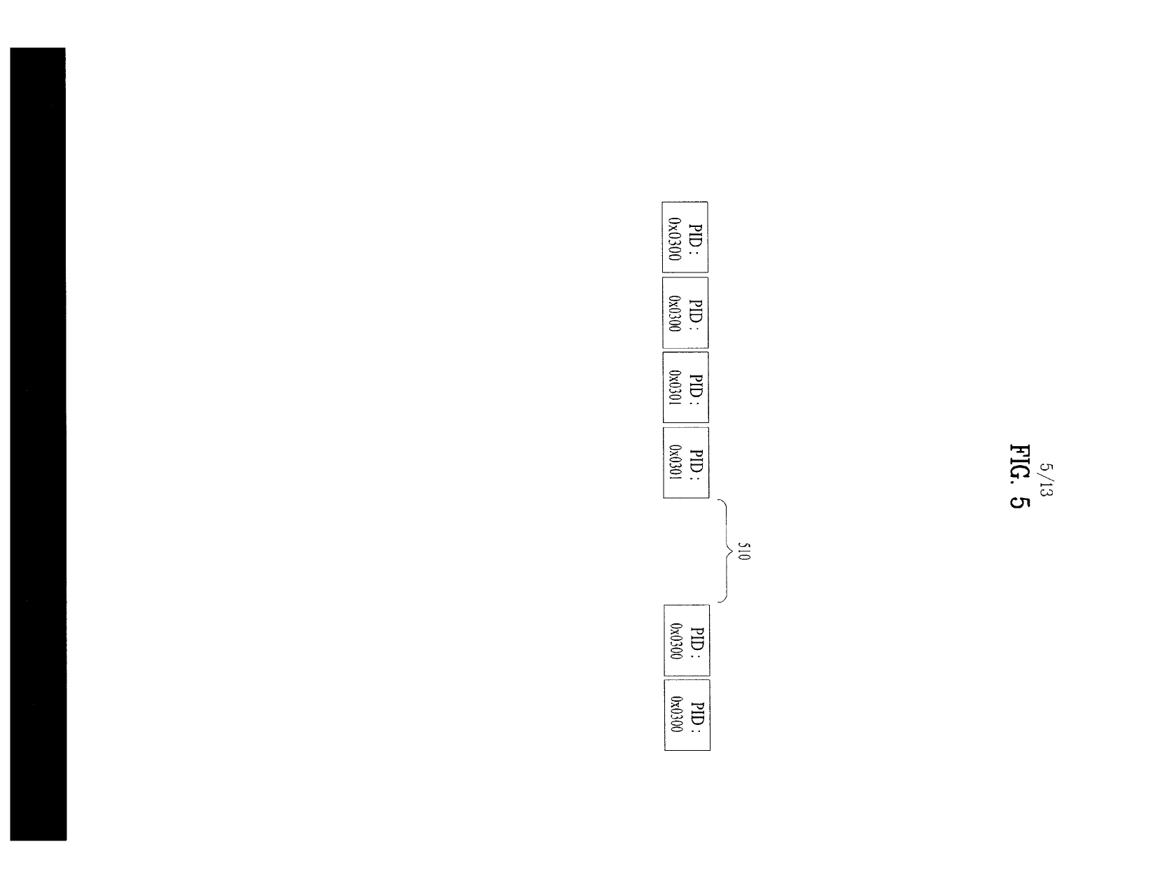

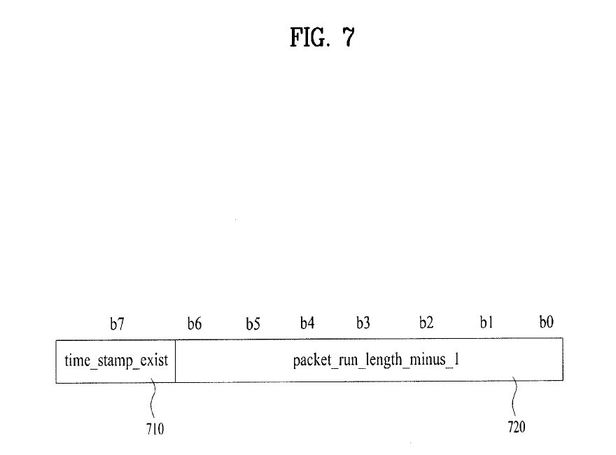

FIG. 4 to FIG. 6 are diagrams illustrating exemplary implementation of time-stamp insertion in a download module according to the present invention. FIG. 7 is a diagram illustrating a data structure of a time-stamp index during use of a time-stamp according to the present invention.

In the illustrated examples of FIG. 4 to FIG. 6, a time-stamp is inserted only when discontinuity occurs instead of being inserted into all transport packets belonging to all transport streams. The scheme by which time-stamps are not necessarily inserted into all transport packets is referred to as an adaptive time-stamp scheme.

Thus, when adaptive time-stamp insertion is used, information indicating whether a time-stamp is inserted into each transport packet may be stored. To this end, a time-stamp index (FIG. 7) indicating whether a time-stamp is present in each transport packet may be used in this specification.

Referring to FIG. 7, a data structure of a time-stamp index when an adaptive time-stamp is used has a size of one byte and includes a time_stamp_exist field 710 of a Most Significant Bit (MSB) of one bit indicating or identifying whether a time-stamp is present in a corresponding transport packet and a packet_run_length_minus_{—1} field 720 of the other bits. The packet_run_length_minus_{—1} field 720 may indicate or identify the number of continuous transport packets to which a time-stamp is not added in the packet. Accordingly, the time-stamp index defined as shown in FIG. 7 may be added in a prescribed unit without being added to all input transport packets using the packet_run_length_minus_{—}1 field 720. In this case, transport packets to which time-stamp indexes are added may be periodically or aperiodically configured by appropriately adjusting a value of the packet_run_length_minus_{—}1 field 720 constituting the time-stamp index, thereby achieving efficiency.

If the packet_run_length_minus_{—}1 field 720 constituting the time-stamp index is not defined, time-stamps may be added to all input transport packets or all transport packets to which time-stamps are not added.

A time-stamp processing method according to the present invention will now be described with reference to FIG. 4 to FIG. 7. Specifically, a method for implementing the time-stamp index shown in FIG. 7 will be described with reference to the illustrated examples of FIG. 4 to FIG. 6.

Referring to FIG. 4, 8 PID streams input to the system decoder 108 are illustrated. The first two PID streams have a PID value of 0x0300 and the next four PID streams sequentially have PID values of 0x0301, 0x0301, 0x0302, and 0x0302. The remaining two PID streams have a PID value of 0x0301.

If PIDs belonging to streams to be downloaded among 8 PID streams shown in FIG. 4 are PID streams having values of 0x0300 and 0x0301, a total of 6 PID streams except for two PIDs having a value of 0x0302 among a total of 8 PID streams is input to the download module 212 through PID filtering as shown in FIG. 5.

Here, the respective PID streams are sequentially input. This is because the PID streams include system clocks input to the system decoder 108 and the PID streams stored in the storage part 216 of the PVR module are reused during playback.

In other words, as shown in FIG. 5, the PID streams input to the download module 212 have a discontinuity interval 510 because a total of 6 PID streams except for two PIDs having a value of 0x0302 (i.e. fifth and sixth PID streams in order) among 8 PID streams initially input to the system decoder 108 is input to the download module 212 through PID filtering.

Accordingly, the download module 212 should perform proper processing for PID streams which are input after the discontinuity interval 510 when the discontinuity interval 510 is generated between PID streams as shown in FIG. 5.

To this end, the adaptive time-stamp scheme according to the present invention may be used. For example, the adaptive time-stamp defined as shown in FIG. 7 is added to a PID stream 610 which is first input after the discontinuity interval 510.

In this case, the time_stamp_exist field 710 of the adaptive time-stamp is defined as a value indicating that a time-stamp is present in a corresponding packet and the subsequent packet_run_length_minus_{—1} field 720 indicates the number of PID streams which are present prior to a next discontinuity interval. Consequently, system efficiency is increased.

In FIG. 7, the time-stamp is defined as one byte so that a range indicating PID streams may be restricted. In this case, the number of bytes defined in a corresponding adaptive time-stamp may be increased or PID streams may be selected within a proper range to add time-stamps. For example, if a run length is 128 or more, a code split is used. Therefore, if 255 packets without a time-stamp are consecutively generated, a PID may be expressed as 0x7F or 0x7D.

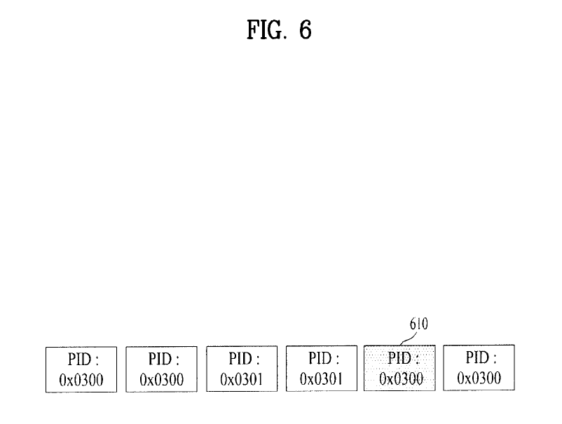

Referring to FIG. 6, a PID stream to which a time-stamp is added may have a size of 192 bytes unlike other PID streams each having a size of 188 bytes.

As described above, time-stamps are added to PID streams input to the download module 212 of FIG. 5. In FIG. 6, 4 consecutive packets without a time-stamp, a packet with a time-stamp, and a packet without a time-stamp are generated to be coded to ‘0x03 0x80 0x00’.

The method for processing a time-stamp in the download module 212 has been described hereinabove with reference to FIG. 4 to FIG. 7.

Hereinafter, a method for configuring an index (which is different from the above-described adaptive time-stamp index) in the download module 212 will be described.

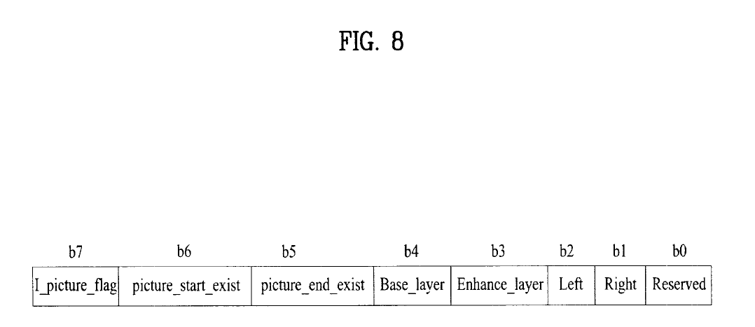

FIG. 8 is a diagram illustrating an exemplary index configuration in the download module 212 according to the present invention.

Referring to FIG. 8, an index defined as one byte includes a total of 8 flags starting from an I_picture_flag of an MSB to a reserved flag of an LSB.

The index includes, in the form of flags, details for carrying out trick play functions, for example, ‘fast forward’ and ‘skip’ which are generally requested and implemented in a PVR.

In a digital receiver, even if a user requests trick play in a PVR playback process, a video decoder performs decoding at a normal speed while actually implementing trick play. Nonetheless, pictures actually decoded by the request of trick play are skipped and input according to corresponding speed so that the user may feel accelerated play or a skip effect.

Then, the upload module 218 should extract data to be input to the (system) decoder and should input the extracted data to the system decoder to smoothly perform trick play. To this end, the location of the corresponding data should be rapidly detected and index information according to the present invention serves to search efficiently and rapidly for data to be input to the decoder by the upload module 218.

Namely, the index information serves to extract additional data so as to rapidly search for a data location from a stored video stream when the digital receiver performs trick play according to a request in a PVR playback process and, specifically, extract data corresponding to a Random Access Point (RAP) when skip, fast forward etc. are performed and generate information so as to be selectively input to the decoder. The RAP may be any one of I, B, and P pictures. To aid in understanding of the present invention and provide convenience of description, an I picture is described as an example of the RAP. This is because use of an I picture which can be independently reproduced as the RAP is more efficient in terms of the system than other reference pictures B and P pictures which cannot be independently reproduced. That is, the I picture refers to a randomly accessible picture.

In addition, the index information may define a 2D/3D related indexing function so as to select a 2D or 3D mode during trick play, in other words, to properly upload a stored stream according to the 2D or 3D mode.

For this purpose, the download module 212 analyzes transport packets stored when generating the index. The download module 212 determines whether the RAP is included in a corresponding transport packet based on the analyzed result. The download module 212 judges whether a video ES included in the corresponding transport packet is left image data or right image data. Further, the download module 212 may determine whether the video ES is a 2D compatible stream in case of a 3D video ES.

The download module 212 may define the above determinations as the index information.

For example, to generate the index, the download module 212 determines whether the index information as shown in FIG. 5 is present in units of each transport packet or a transport packet group (e.g. a group of 100 transport packets or a variable number of packets so as to generate an index at every I picture start). The download module 212 transmits the determined result to the index and file DB. The index and file DB maps and manages a corresponding index and a physical location in which a transport packet is stored. In case of an RAP in a 3D mode, a video ES of an enhancement layer need not necessarily be an I picture.

For example, the download module 212 receives a transport packet to be stored as input data but generates, as output data, a transport packet including an index which includes information as to whether an I picture start or a start byte of an RAP is included in each transport packet, information about an ES including the location of the I picture start, and information about a view type. The information about view type may include information as to whether the transport packet is compatible with a 2D packet and information as to whether a right view is included.

Referring to FIG. 8, an index configured in the download module 212 may be generated every packet. In this case, the index includes an I_picture_flag flag indicating whether an I picture is present, a picture_start_exist flag indicating whether a picture start is present, a picture_end_exist flag indicating a picture end is present, a Base_layer flag indicating whether a layer is a base layer, an Enhance_layer flag indicating whether a layer is an enhancement layer, a Left flag indicating whether image data is left image data, a Right flag indicating whether image data is right image data, and a Reserved flag indicating whether a packet is reserved for future use, sequentially starting from an MBS of the index.

The digital receiver is able to identify codec information of the enhancement layer based on signaling information in a received digital signal. The system decoder 108 is able to recognize that a corresponding video stream is composed of a dual stream by storing the Enhance_layer flag in the configuration of the index of FIG. 8. Notably, the Enhance_layer flag may be meaningless in itself because a video ES of the enhancement layer is based on a video ES of the base layer. Accordingly, if the Enhance_layer flag is inactivated, the digital receiver may recognize that a corresponding video stream is a single video stream. At this time, the Base_layer flag may be activated because the base layer itself can define related information in correspondence to a single video stream.

The Left or Right flag can be used for determination as to whether to view a 2D mode such as view switching based on left image data or right image data, in addition to identification as to whether corresponding data is left image data or right image data during 3D mode view. As described earlier, if view switching is requested, information about the Left and Right flags may be used.

Description of the download module 212 has been given in detail hereinabove. Next, the upload module 218 for uploading transport packets for a video ES during PVR playback will be described in detail.

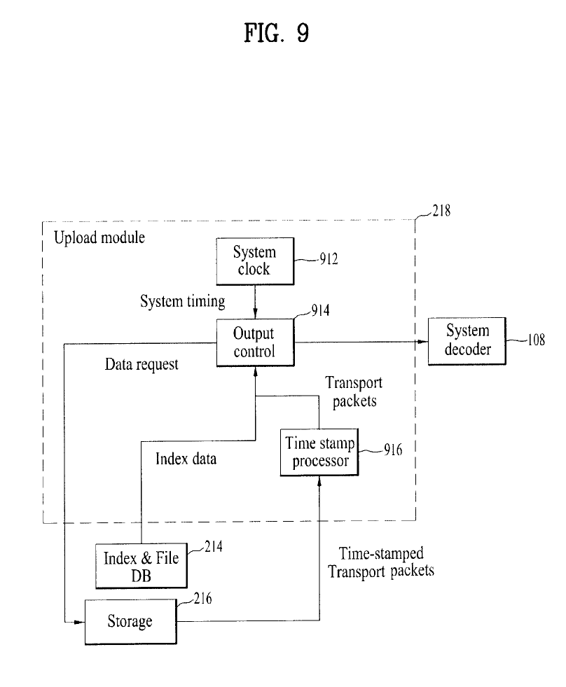

FIG. 9 is a block diagram illustrating an exemplary configuration of the upload module 218 included in the 3D PVR module of FIG. 2.

In FIG. 9, the upload module 218 enables PVR playback by inputting transport packets received from the storage part 216 to the system decoder 108 at a proper timing when content stored or recorded in the storage part 216 of the PVR is played back.

If an input transport packet is a 192-byte time-stamped transport stream, the upload module 218 eliminates a 4-byte time-stamp from the time-stamped transport stream so that each 188-byte packet which can be processed in the system decoder 108 and the video decoder 112 may be input to the system decoder 108 in synchronization with a timing based on the eliminated time-stamp.

If trick play is requested, the upload module 218 may selectively receive only a proper transport packet based on the index information configured as shown in FIG. 8 extracted from the index and file DB 214 and may output the received transport packet to the system decoder 108.

Referring to FIG. 9, the upload module 218 according to the present invention may include a system clock part 912, an output controller 913, and a time-stamp processor 916.

The system clock part 912 provides information about a system clock to be referred to when the output controller 914 performs output control of a corresponding transport packet.

The output controller 914 receives index data from the index and file DB 214 and requests the storage part 216 to transmit data. The output controller 914 may request data based on the received index data. The storage part 216 transmits corresponding transport packets to the time-stamp processor 916 according to the request of the output controller 914. The transport packets output from the storage part 216 may all be time-stamped transport packets or partially time-stamped transport packets.

The time-stamp processor 916 eliminates a time-stamp from input transport packets and directly provides only 188-byte transport packets to the output controller 914 or the system decoder 108. If the transport packets are transmitted to the system decoder 108, the output controller 914 may calculate a system timing according to the system clock of the system clock part 912 and output a control signal to the stamp processor 916.

In the above process, a transmission timing to the system decoder 108 refers to the eliminated time-stamp. If a system time value generated from the system clock part 912 is equal to a value of the time-stamp, a corresponding transport packet is input to the system decoder 108.

In case of a transport packet without a time-stamp, an output timing may be calculated using a virtual time-stamp value with reference to a bit rate which is input during recording. The virtual time-stamp may be generated from the above-described download module 212 in the 3D PVR module or may be generated from an additional configuration. The upload module 218 may identify whether the time-stamp is present with reference to the above-described time-stamp index. The length of each transport packet and the presence/absence of the time-stamp can be discerned through the time-stamp index.

Although the above description has been given without distinction of index information, the index information is basically used only during trick play even while a PVR performs playback. In other words, the output controller 914 in FIG. 9 does not always receive index data and request the storage part 216 to transmit data. Rather, the output controller 914 may request data output which is not based on the index data, during normal playback. Namely, during non-trick playback, the index and file DB 214 need not access the output controller 914.

When trick play is performed in the PVR module 110 in the digital receiver, the upload module 128 determines the number of pictures to be skipped in software/middleware, etc. according to an operation mode and selects a picture to be reproduced. For example, the PVR module 110 may perform playback while skipping two I pictures when performing fast playback among trick play functions. The PVR module 110 may determine the start and end locations of the first I picture with reference to an index file input from the index and file DB 214. The upload module 218 may read transport packets for a corresponding interval from the storage part 216.

Thereafter, the upload module 218 may read transport packet data of a corresponding location of a 4th I picture, a 7th I picture, a 10th I picture, etc. while skipping two I pictures, based on input index information and input the transport packet data to the system decoder 108.

While the upload module 218 processes data to be provided to the system decoder 108 and the video decoder 112 at a normal speed during a playback process, fast playback can be performed because input data is skipped data. For example, when an I picture period is 10 sheets, a fast playback effect of 30 times (30×) is obtained.

Hereinafter, a method for performing PVR functions according to various usage scenarios of the digital receiver will be described based on the above description.

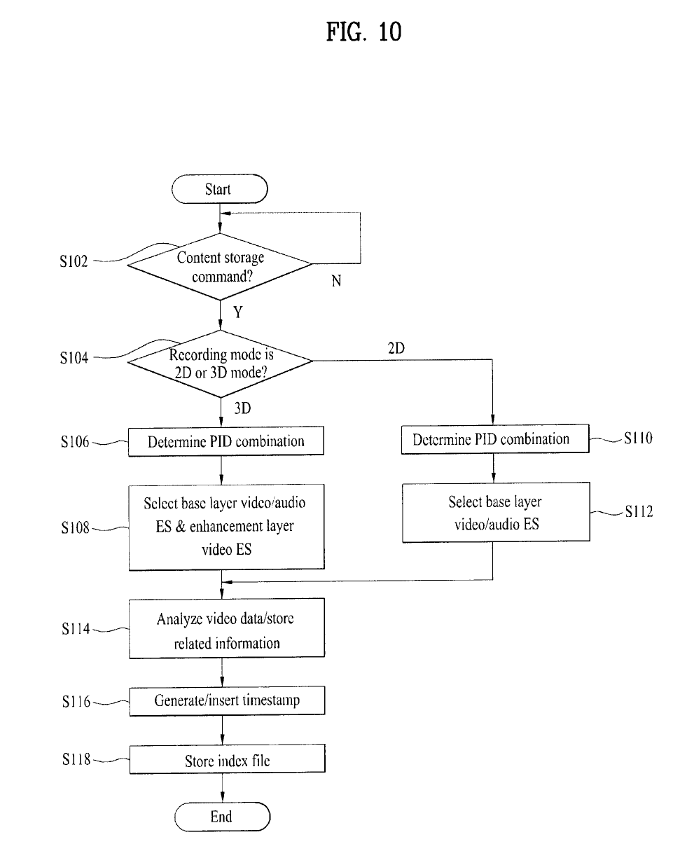

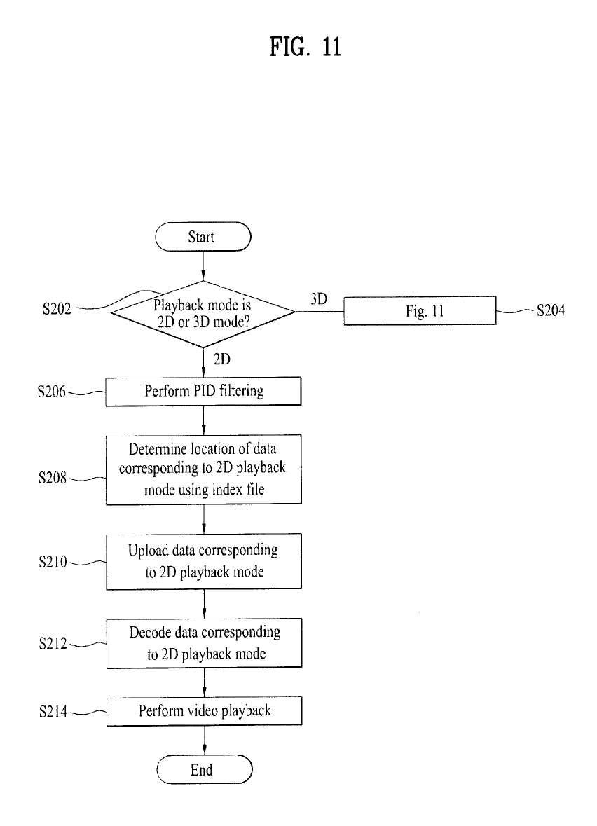

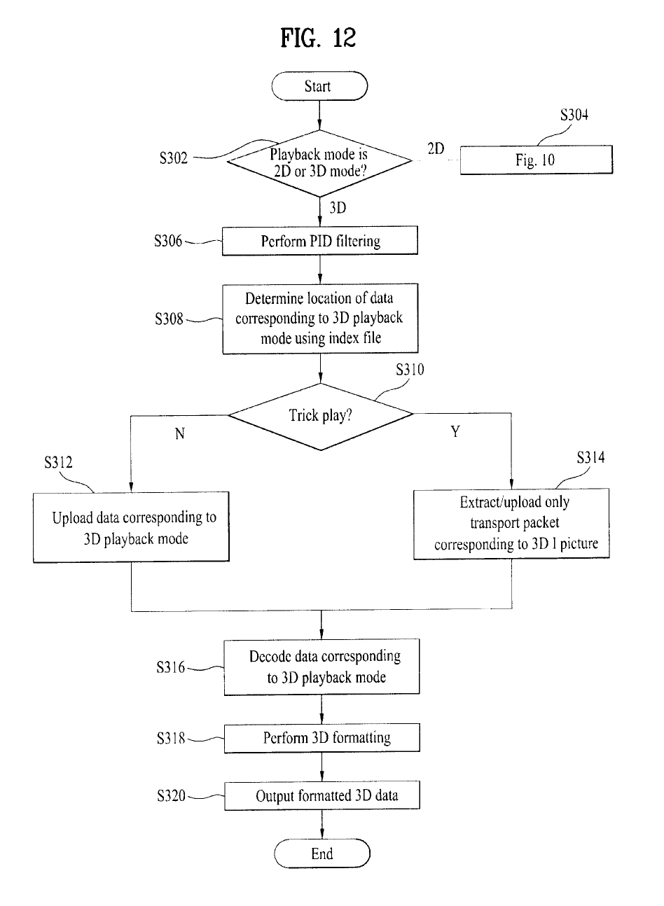

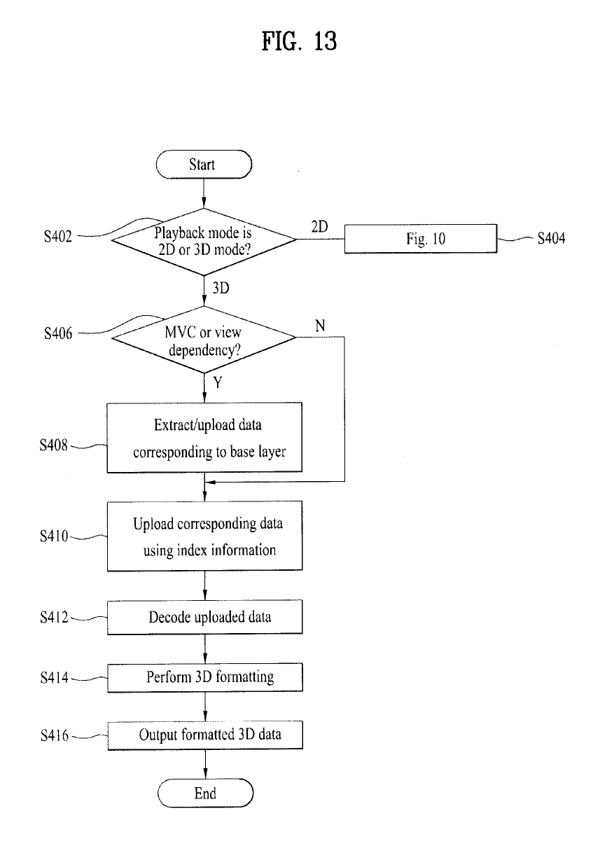

FIG. 10 is a flowchart illustrating an exemplary operation of the receiver during 2D/3D recording according to the present invention.

For example, FIG. 10 explains an operation for recording or storing an input transport stream in a 2D/3D mode in the digital receiver. An operation prior to a procedure of processing an initial transport stream in the system decoder 108 via the receiver 102 and the VSB decoder 104 is as described previously and a detailed description thereof will not be given herein.

The system decoder 108 determines whether a PVR function execution request, i.e. a content storage command or request, is received from a user (S 102). If no content storage command is received, the system decoder 108 processes an input transport stream and perform a control function so that the transport stream is output via the demultiplexer and the video decoder 112. Proper processing of the transport stream may be performed with reference to the above description according to whether the input transport stream is a 2D or 3D transport stream. For example, if the input transport stream is a 3D video stream, the transport stream is converted into a 3D output form through the formatter 116 and the 3D output stream is displayed.

If the content storage command or request is received from a user as result of determination in step S102, the system decoder 108 determines whether a recording mode is a 2D or 3D mode (S104). According to a requested recording mode, the system decoder 108 needs to appropriately control the operation of the PVR module 110 which may vary with the recording mode as described above.

If the recording mode is a 3D mode as result of determination in step S104, the system decoder 108 determines a PID combination so that a transport packet for a video ES to be input to the PVR module 110 through the demultiplexer can be processed (S 106).

The system decoder 108 performs filtering for PID streams to be input to the PVR module 110 according to the determined PID combination in step S106. The system decoder 108 selects a base layer video/audio ES and an enhancement layer video ES from among transport packets which are input through the demultiplexer and performs a control function so that the selected ESs can be input to the PVR module 110 (S 108).

If the recording mode is determined to be a 2D mode in step S 104, the system decoder 108 determines a PID combination so that a transport packet for a video ES to be input to the PVR module 110 through the demultiplexer can be processed (S 110).

The system decoder 108 performs filtering for PID streams to be input to the PVR module 110 according to the determined PID combination in step S106. The system decoder 108 selects a base layer video/audio ES from among transport packets which are input through the demultiplexer and performs a control function so that the selected ESs can be input to the PVR module 110 (S112).

After step S108 or S112, the PVR module 110 analyzes video data for input video ESs according to control of the system decoder 108 and stores related information (S114).

The PVR module 110 generates and inserts a time-stamp for a transport packet according to the methods described with reference to FIG. 4 to FIG. 7 based on the analyzed result for the video data in step S114 and stores the time-stamp in the storage part 216 (S116).

The PVR module 110 generates an index file in a manner described with reference to FIG. 8 so that trick play among PVR functions can be performed and stores the index file in the index and file DB 214, after step S116 or at the same time as step S116 (S 118).

In step S118, the index processing part of the download module 212 may analyze video data. A main operation of analysis serves to determine whether an I picture is present. For example, it is determined whether information about start and end points of the I picture, information as to whether the I picture is a left or right image, and information as to whether the I picture is composed of a base layer or an enhancement layer is stored and performs a proper operation according to a determined result.

The download module 212 designates, using a system clock, a time at which each input transport packet is input to the system decoder 108, i.e. a system time, as a time-stamp and inserts the time-stamp into a transport packet. Especially, if an adaptive time-stamp is used, the download module may judge whether transport packets are discontinuous and determine and control time-stamp insertion according to the determined result.

FIG. 11 is a flowchart illustrating an exemplary operation of the receiver during 2D mode playback according to the present invention.

For example, FIG. 11 explains a playback operation for stored content in order to perform a PVR function as illustrated in FIG. 10. The stored content may be 2D content or 3D content.

The upload module 218 determines whether a playback mode is a 2D or 3D mode (step S202). If the playback mode is a 3D mode, reference is made to FIG. 12 which will be described later (S204) and, therefore, a detailed description is omitted here.

If the playback mode is a 2D mode as result of determination in the upload module 218, the upload module 218 performs PID filtering in order to input a PID stream corresponding to a video ES to be uploaded to the system decoder 108 (S206).

The upload module 218 reads an index file from the index and file DB 214 to perform upload control for the video ES to be reproduced and determines a location of data in the storage part 216, corresponding to the 2D playback mode, based on the read index file (S208). That is, in case of a dual stream, the upload module 218 receives only a base layer ES and skips a video ES corresponding to an enhancement layer video ES. However, in case of normal speed playback, 2D mode playback in which an enhancement layer is omitted can be performed without any timing problem by a PID filtering operation of a subsequent stage (demultiplexer 108) even though the enhancement layer video ES is not skipped.

The upload module 218 uploads the data corresponding to the 2D playback mode according to a system timing (S210) and decodes the data corresponding to the 2D playback mode through the system decoder/demultiplexer 108 and the video decoder 112 (S212), thereby performing video playback (S214).

Here, if trick play is selected, it may be desirable that the upload module 218 output only data corresponding to a 2D mode in order to guarantee normal operation of the system decoder 108 and the video decoder 112.

FIG. 12 is a flowchart illustrating an exemplary operation of the digital receiver during 3D mode playback according to the present invention.

Unlike FIG. 11, FIG. 12 illustrates operation of the digital receiver during 3D mode playback and may be performed when the playback mode is a 3D mode as result of determination in step S202.

That is, the upload module 218 determines whether a playback mode is a 2D or 3D mode (S302). If the playback mode is a 2D mode, reference is made to the above description of FIG. 11 (S304).

If the playback mode is a 3D mode as result of determination, the upload module 218 performs PID filtering in order to input a PID stream corresponding to a video ES to be uploaded to the system decoder 108 (S306).

The upload module 218 reads an index file from the index and file DB 214 to perform upload control for the video ES to be reproduced and determines a location of data in the storage part 216, corresponding to the 3D playback mode, based on the read index file (S308).

After step S308, the upload module 218 determines whether a trick play request is received (S310).

If no trick play request is received as result of determination in step S310, the upload module 218 uploads all video ESs downloaded during storage in the 3D mode based on the determined location of the 3D data (S312).

If the trick play request is received as result of determination in step S310, the upload module 218 extracts and uploads only a transport packet corresponding to a 3D I picture (S314).

The upload module 218 performs decoding for the data corresponding to the 3D playback mode uploaded in the decoder/demultiplexer 108 and the video decoder 112 (S316) and performs 3D formatting according to an output format of the formatter 116 (S318).

The upload module 218 outputs the formatted 3D data (S320).

If base and enhancement video data designated as an I picture is uploaded, a final output video is generated through mode conversion in the formatter by decoding the I picture of the base and enhancement layers.

FIG. 13 is flowchart illustrating an exemplary operation of the digital receiver during a view switching request according to the present invention.

FIG. 13 explains operation when left/right conversion is requested during a playback process.

The upload module 218 determines a playback mode (S402). If the playback mode is a 2D mode, the upload module 218 performs the procedure shown in FIG. 10 (S404).

If the playback mode is a 3D mode, the upload module 218 determines whether an MVC or view dependency is present (S406) because all information corresponding to a base layer should be uploaded upon presence of the MVC or view dependency (S408).

After step S408, the upload module 218 uploads corresponding data using index information (S410).

The upload module 218 decodes data corresponding to the 3D playback mode, uploaded in the decoder/demultiplexer 108 and the video decoder 112 (S412), and performs 3D formatting according to an output format of the formatter 116 (S414).

The upload module 218 outputs the formatted 3D data (S416).

In the decoding process, both a left view and a right view are processed but only a view selected in a final display process may be output. Although not shown in the drawing, the digital receiver may select a desired view prior to final output before or after the decoding process.

### MODE FOR INVENTION

Various embodiments have been described in the best mode for carrying out the invention.

According to the aforementioned present invention, the digital receiver can provide various PVR functions for 3D content. The digital receiver can support an effective PVR function even for a 3D stream for full-resolution-per-eye implementation and trick play and 2D/3D conversion can be smoothly performed even for 3D content using a PVR.

For convenience of description, the drawings have been separately described. However, a new embodiment may be implemented by integrating the embodiments described in each drawing. According to the necessity of those skilled in the art, designing a recording medium which is readable by a computer in which programs for carrying output the above-described embodiments are stored is within the range of the present invention.

The digital receiver and operation method thereof according to the present invention are not limitedly applied to the above-described embodiments. Rather, all or a part of the above embodiments may be configured through combination so that various modifications thereof can be made.

The digital receiver and operation method thereof according to the present invention may be achieved through a recording medium which is readable by the processor included in the display device as code which is readable by the processor. The recording medium includes all types of recording devices in which processor readable data can be stored. The recoding medium includes, for example, a ROM, RAM, CD-ROM, magnetic tape, floppy disk, optical data storage unit, etc. and may be achieved through a carrier wave form such as transmission via the Internet. The processor readable recording media may be distributed to a computer system connected to a network and processor readable code may be stored and implemented in the recording media in a distributed manner.

Those skilled in the art will appreciate that the present invention may be embodied in other specific forms than those set forth herein without departing from the spirit and essential characteristics of the present invention. The above description is therefore to be construed in all aspects as illustrative and not restrictive. The scope of the invention should be determined by reasonable interpretation of the appended claims and all changes coming within the equivalency range of the invention are intended to be within the scope of the invention.

While both a product invention and a process invention have been described in the present specification, a description of the two inventions may be supplementarily applied as needed.

### INDUSTRIAL APPLICABILITY

The present invention relates to processing of 3D content in a digital receiver including a PVR device capable of receiving and storing 3D signals and can be used in all fields of the digital receiver.

1. A method for processing a digital broadcast signal for a 3-dimensional (3D) service, comprising:
adding a time-stamp to an input 3D video elementary stream and storing the time-stamped 3D video elementary stream;
extracting the stored 3D video elementary stream and uploading the extracted 3D video elementary stream based on a system clock based on a time-stamp value of the extracted 3D video elementary stream;
decoding the uploaded 3D video elementary stream; and
formatting decoded 3D video data to suit an output format and outputting the formatted 3D video data.

2. The method of claim 1, further comprising:
analyzing the input 3D video elementary stream; and
generating and storing index data for trick play according to the analyzed result.

3. The method of claim 2, wherein the 3D video elementary stream is a dual video stream composed of a base layer video stream and an enhancement layer video stream.

4. The method of claim 3, wherein the time-stamp is added to a transport packet of a prescribed unit among transport packets for the input 3D video elementary stream.

5. The method of claim 3, wherein the time-stamp is added to a first transport packet received after a discontinuity interval generated during a packet identifier (PID) filtering process, among transport packets for the input 3D video elementary stream.

6. The method of claim 4 or 5, wherein the time-stamp includes at least one of a first flag indicating whether a time-stamp is present in a corresponding transport packet and a second flag indicating run length from the corresponding transport packet to a next time-stamped transport packet.

7. The method of claim 6, wherein the time-stamp is added in a prescribed unit or when discontinuity is not generated, based on a value of the second flag.

8. The method of claim 3, wherein the index data includes information as to whether an I picture is present in a corresponding packet, information about start and end locations of the I picture, and information as to whether the packet is left image data or right image data, in association with a transport packet for the input 3D video elementary stream.

9. The method of claim 8, wherein the index data further includes information indicating whether the elementary stream is a base layer elementary stream or an enhancement layer elementary stream.

10. The method of claim 9, wherein the time-stamped transport packet has a size of 192 bytes and the time-stamp is eliminated from the time-stamped transport packet prior to upload.

11. A digital receiver for a 3-dimensional (3D) service, comprising:
a Personal Video Recorder (PVR) module including a download module for adding a time-stamp to an input 3D video elementary stream and storing the time-stamped 3D video elementary stream and an upload module for extracting the stored 3D video elementary stream and uploading the extracted 3D video elementary stream according to a system clock based on a time-stamp value of the extracted 3D video elementary stream;
a decoder for decoding the uploaded 3D video elementary stream;
a formatter for formatting decoded 3D video data to suit an output format; and
an output part for outputting the formatted 3D video data.

12. The digital receiver of claim 11, wherein the download module:
analyzes the input 3D video elementary stream; and
generates and stores index data for trick play according to the analyzed result.

13. The digital receiver of claim 12, wherein the 3D video elementary stream is a dual video stream composed of a base layer video stream and an enhancement layer video stream.

14. The digital receiver of claim 13, wherein the download module adds the time-stamp to a transport packet of a prescribed unit among transport packets for the input 3D video elementary stream.

15. The digital receiver of claim 13, wherein the download modules adds the time-stamp to a first transport packet received after a discontinuity interval generated during a packet identifier (PID) filtering process, among transport packets for the input 3D video elementary stream.

16. The digital receiver of claim 14 or 15, wherein the time-stamp includes at least one of a first flag indicating whether a time-stamp is present in a corresponding transport packet and a second flag indicating run length from the corresponding transport packet to a next time-stamped transport packet.

17. The digital receiver of claim 16, wherein the download module adds the time-stamp in a prescribed unit or when discontinuity is not generated, based on a value of the second flag.

18. The digital receiver of claim 13, wherein the download module includes, in the index data, information as to whether an I picture is present in a corresponding packet, information about start and end locations of the I picture, and information as to whether the packet is left image data or right image data, in association with a transport packet for the input 3D video elementary stream.

19. The digital receiver of claim 18, wherein the index data further includes information indicating whether the elementary stream is a base layer elementary stream or an enhancement layer elementary stream.

20. The digital receiver of claim 19, wherein the upload module eliminates the from the time-stamped transport packet having a size of 192 bytes prior to upload.
